(19) United States
(12) Patent Application Publication
(10) Pub. No.: US 2025/0141279 A1
(43) Pub. Date: May 1, 2025

(54) Stator and Electrical Machine

(71) Applicant: FEAAM GmbH, Neubiberg (DE)

(72) Inventor: Gurakuq DAJAKU, Neubiberg (DE)

(73) Assignee: FEAAM GmbH, Neubiberg (DE)

(21) Appl. No.: 18/834,568

(22) PCT Filed: Jan. 31, 2023
(86) PCT No.: PCT/EP2023/052329

§ 371 Date: Jul. 30, 2024

(30) Foreign Application Priority Data
Feb. 1, 2022 (DE) 10 2022 102 321.4

(51) Int. Cl. H02K 1/14; H02K 1/2706; H02K 3/28

(52) U.S. Cl. CPC H02K 1/148; H02K 1/2706; H02K 3/28

(57) ABSTRACT

A stator for an electrical machine includes a plurality of stator teeth distributed along the circumference of the stator and grooves formed between the stator teeth. Coils of different phases are wound around respective teeth formed between the slots. The number of phases is greater than three. At least one unwound tooth is provided between each of the wound teeth. At least one of the wound teeth has a recess which extends substantially in a radial direction and is arranged in a tooth region, or at least one of the at least one unwound tooth has a recess which extends substantially in a radial direction and is arranged in a tooth region.

### CROSS-REFERENCE TO RELATED APPLICATION(S)

This is a U.S. national stage of PCT International Application No. PCT/EP2023/052329 filed on Jan. 31, 2023, the entire contents of which are incorporated herein by reference for all purposes, and which claims the benefit of and priority to German Patent Application No. 10 2022 102 321.4 filed on Feb. 1, 2022.

### DESCRIPTION

The present application relates to a stator for an electrical machine and an electrical machine with the stator.

In the last two decades, fractional-slot concentrated windings (FSCWs) have been increasingly used in synchronous machines in numerous applications. The reasons for this are the ease of manufacture and attractive characteristics such as a good power-to-weight ratio, low copper losses, good fault tolerances, non-overlapping coils and short winding heads.

FSCWs can be designed as a single-layer winding or as a multilayer winding. The subject of the present patent application is single-layer winding.

In such machines, the fundamental waves of the magnetomotive force are often not used as the working wave, but a higher harmonic, for example the fifth or seventh harmonic of the magnetomotive force.

It is desirable to amplify the working wave in relation to the other harmonic components, including the fundamental waves, or to suppress or reduce the undesirable components of the magnetomotive force.

This problem is solved with the objects of the independent patent claims.

Further developments and advantageous embodiments are given in the dependent patent claims.

In one embodiment, a stator for an electrical machine has a plurality of stator teeth distributed along the circumference of the stator, between each of which grooves are formed, with coils of different phases each being wound around teeth formed between the grooves. The number of phases is greater than three.

This is a stator for a machine with four or more different electrical phases, which are also referred to as multiphase machines.

At least one unwrapped tooth is provided between each of the wrapped teeth.

In one embodiment, a recess is provided in at least one of the wound teeth, which recess extends essentially in the radial direction and is arranged in the tooth region.

In one embodiment, the recess is provided in the at least one unwound tooth, and is substantially extended in the radial direction and arranged in the tooth region.

In other words, the recess extending in the radial direction can be provided in the area of the unwound tooth or in the area of a wound tooth.

In both cases, the additional recess in the tooth area amplifies the working wave, for example the fourth or sixth harmonic of the magnetomotive force, while other significant harmonic components of the magnetomotive force, in particular the fundamental waves, are significantly reduced.

In one embodiment, all wound teeth of the stator or all unwound teeth of the stator have a recess as described above, which is extended in the tooth region in the radial direction.

In one embodiment, the recess can extend from a side of the stator facing the air gap, i.e. in the direction of the axis of the machine, outwards through the yoke of the stator.

In one embodiment, the recess forms a mechanical barrier to reduce the fundamental waves of the magnetic flux.

According to one version, the distance between the recesses is twice the distance between the grooves when viewed in the circumferential direction.

In one embodiment, the grooves run in an axial direction and are arranged parallel to each other.

In one embodiment, the stator is designed so that a higher harmonic of the magnetomotive force that is different from the fundamental waves is used as the working wave.

In one embodiment, a multiphase single-layer winding comprising the aforementioned coils is inserted into the grooves.

The single-layer winding can comprise coils of at least five different phases.

In one embodiment, all coils have the same winding direction and the same coil sequence.

In one embodiment, each coil can be fed by an individual electrical phase.

In another embodiment, the stator teeth are alternately wound and unwound along the circumference of the stator.

The stator teeth can be distributed symmetrically along the circumference of the stator. This means that all slots have the same distance from each other when viewed in the circumferential direction.

In one embodiment, an electrical machine with a stator described above and a rotor is provided.

The rotor can be designed as a PM rotor so that it comprises a large number of permanent magnets. The permanent magnets can, for example, be alternately magnetized as north pole and south pole.

Further details and embodiments of the proposed principle are shown below in several embodiment examples by means of drawings. These show:

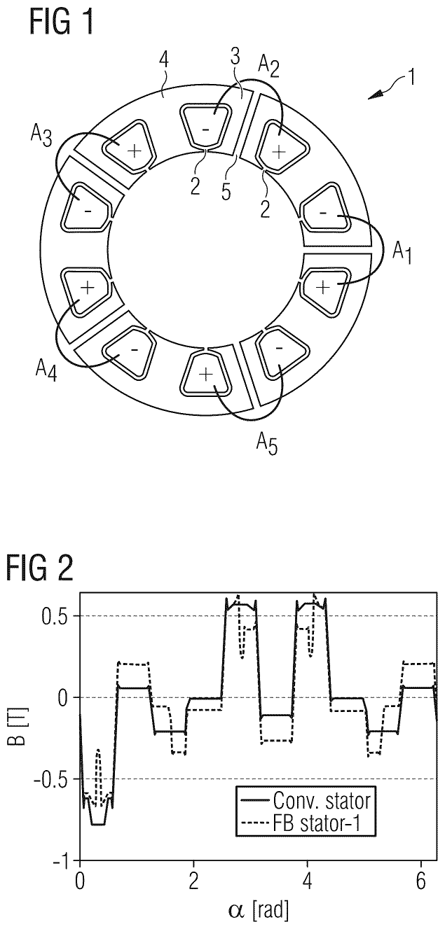

FIG. 1 shows an example of a stator for an electrical machine based on the proposed principle,

FIG. 2 is a diagram of the flux density distribution for FIG. 1,

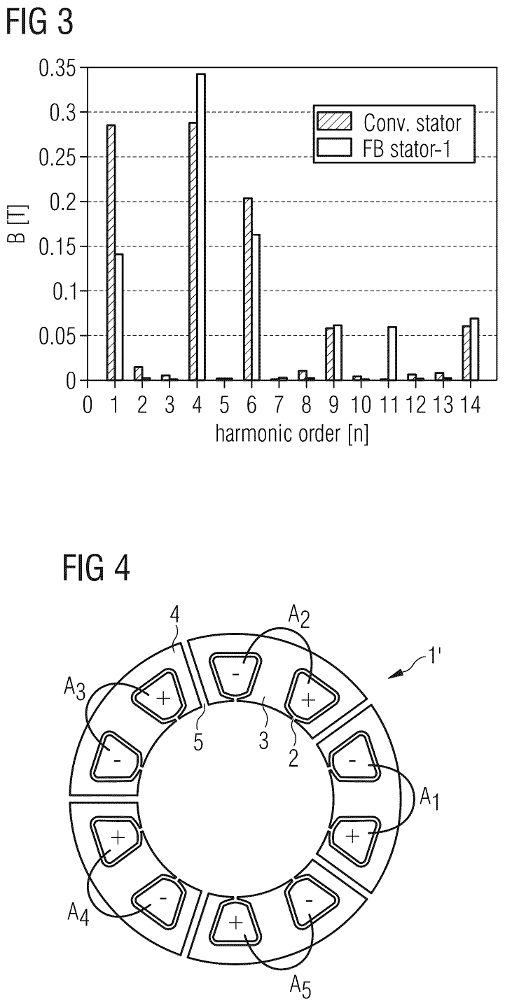

FIG. 3 is a diagram of the harmonic components of FIG. 1,

FIG. 4 shows another example of a stator for an electrical machine based on the proposed principle,

FIG. 5 is a diagram of the flux density distribution for FIG. 4,

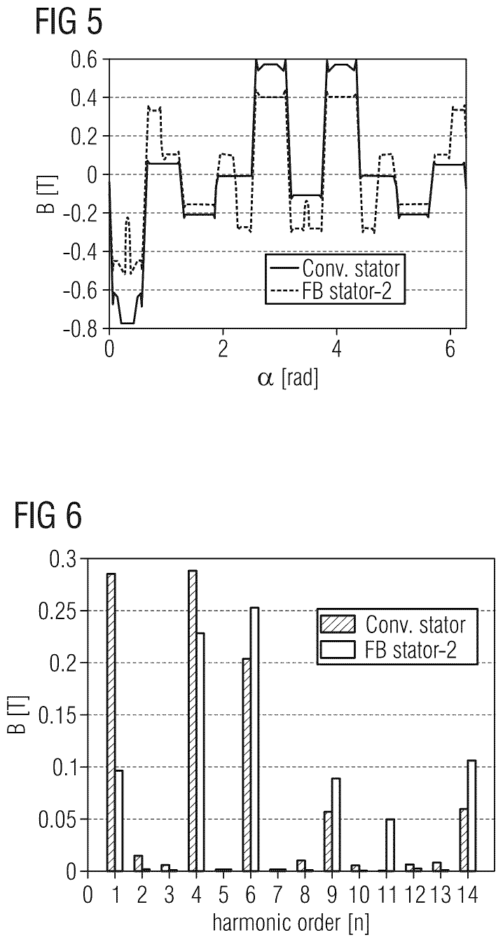

FIG. 6 is a diagram of the harmonic components of FIG. 4,

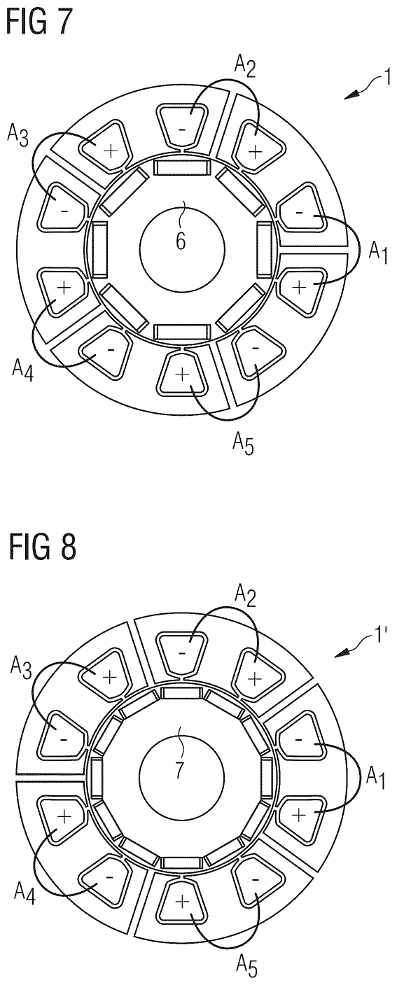

FIG. 7 is an example of an electrical machine based on the proposed principle,

FIG. 8 shows another example of an electrical machine based on the proposed principle,

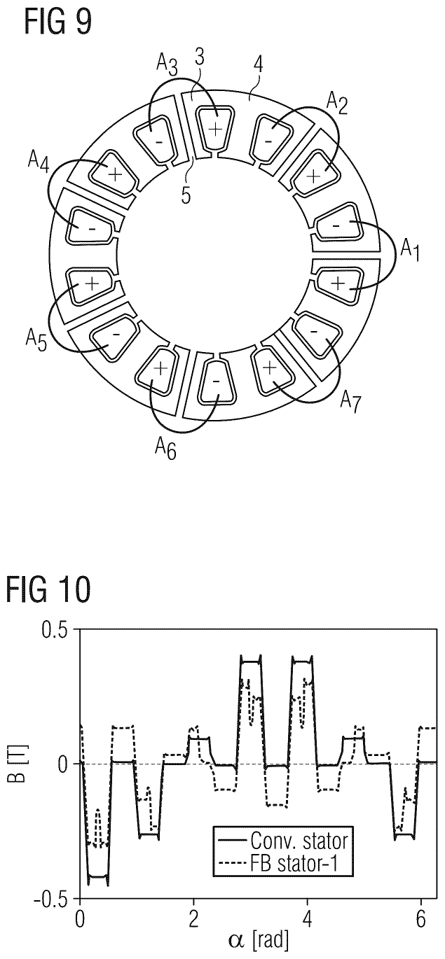

FIG. 9 shows another example of a stator for an electrical machine based on the proposed principle,

FIG. 10 is a diagram of the flux density distribution for FIG. 9,

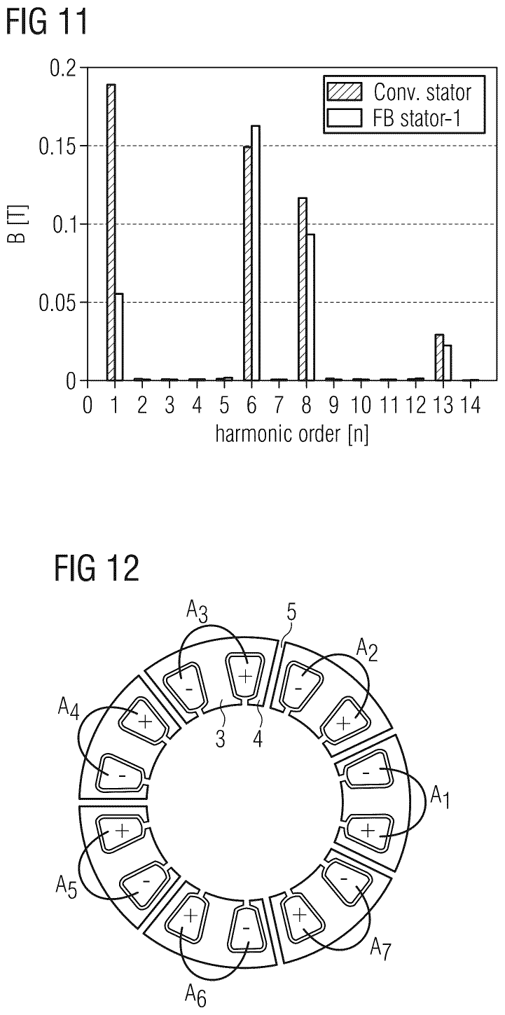

FIG. 11 is a diagram of the harmonic components of FIG. 9,

FIG. 12 is another example of a stator for an electrical machine based on the proposed principle,

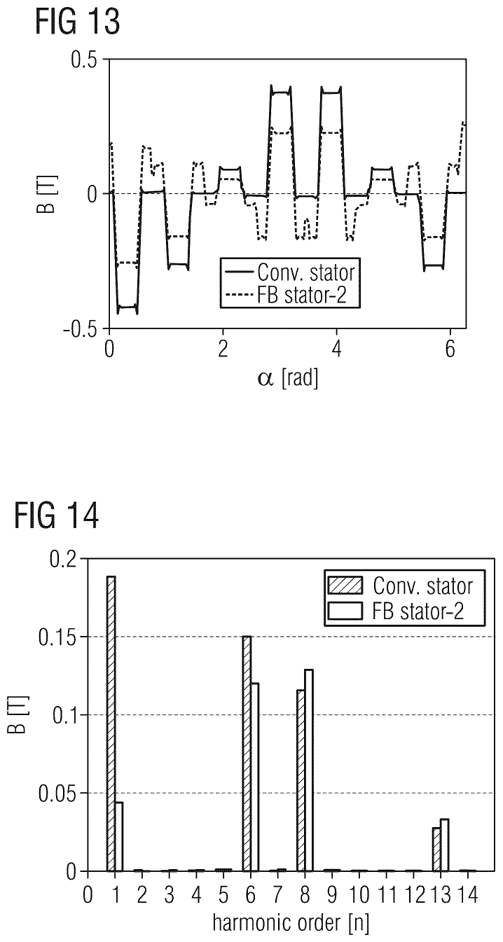

FIG. 13 is a diagram of the flux density distribution for FIG. 12,

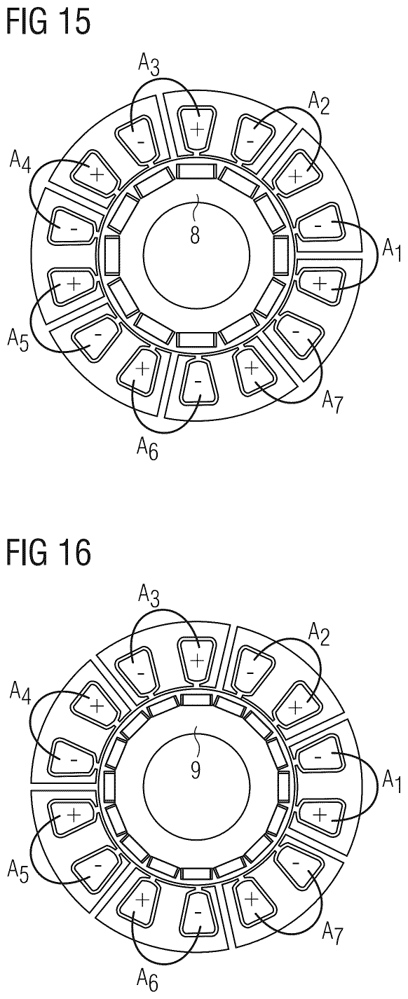

FIG. 14 is a diagram of the harmonic components of FIG. 12,

FIG. 15 shows another example of an electrical machine based on the proposed principle,

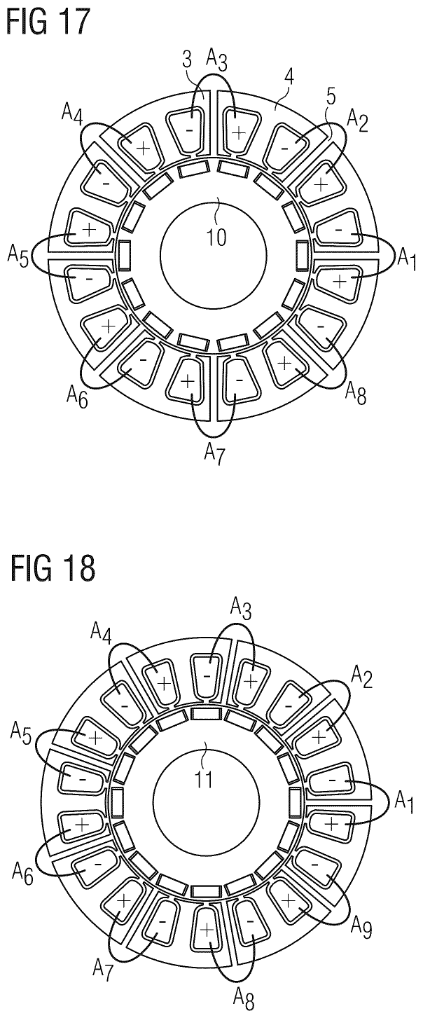

FIG. 16 shows another example of an electrical machine based on the proposed principle,

FIG. 17 shows another example of an electrical machine based on the proposed principle,

FIG. 18 a further example of an electrical machine according to the proposed principle and

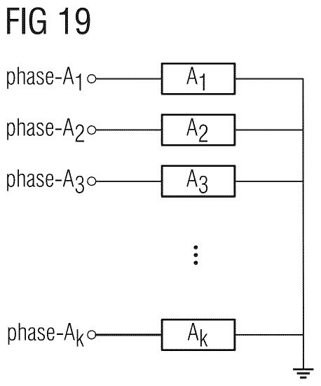

FIG. 19 is an example of an electrical equivalent circuit diagram of a multiphase winding.

FIG. 1 shows a first example of a stator for an electrical machine based on the proposed principle.

The stator 1 comprises a total of ten grooves 2, which are distributed along the circumference and extended in the axial direction of the stator. Stator teeth are formed between the slots. A five-phase single-layer FSCW winding is inserted into the slots, whereby the coils of the respective phase are labeled A1 to A5. The coils are wound around teeth 3, with an unwound tooth 4 remaining between each of the wound teeth 3. The wound teeth 3 each have a recess 5, which extends in the radial direction from the side of the stator facing the air gap through to an opposite yoke area.

FIG. 2 shows the flux density distribution in the air gap in comparison with the design shown in FIG. 1 with a conventional stator, which is constructed as in FIG. 1 but has no recesses 5.

FIG. 3 also shows this comparison, but using the distribution of the harmonics of the flux density distribution. It can be seen that the fourth harmonic is amplified. This is used here as the working wave. The fundamental waves, i.e. the first order harmonic, is significantly reduced, namely to approximately half.

FIG. 4 shows an alternative embodiment to the embodiment according to FIG. 1. In the embodiment according to FIG. 4, the recesses 5 are not formed in the tooth region of the wound teeth 3, but in the tooth region of the unwound teeth 4. Apart from this, the embodiments of FIGS. 1 and 4 correspond to each other and are not described again at this point.

As can be seen from the associated diagrams in FIGS. 5 and 6, which in turn describe the flux density distribution on the one hand and the distribution of the harmonic components on the other, the sixth harmonic is reinforced here by the mechanical flux barriers with the recesses 5, so that the sixth harmonic is used as a working wave. The fundamental waves are reduced by more than 50%. It can also be seen that not only the fundamental waves are reduced, but also other sub-harmonics, i.e. harmonics with an atomic number lower than the atomic number of the working wave, for example the fourth harmonic is also significantly reduced. The second and third harmonics are also reduced, albeit at a lower level.

FIG. 7 shows an example of an electrical machine with the stator of FIG. 1 and an additional internal rotor 6. The rotor 6 is designed as a PM rotor with eight permanent magnets distributed along its circumference, which are alternately magnetized as north and south poles, for example, and form a total of four pole pairs. The four pole pairs are tuned to the working wave, namely the fourth harmonic.

FIG. 8 shows an example of an electrical machine with the stator 1′ of FIG. 4 and a rotor 7, which has a total of 12 permanent magnets along its circumference and thus realizes the number of pole pairs of six. The number of pole pairs six is matched to the working wave of this design example, namely the sixth harmonic of the magnetomotive force.

Based on FIG. 1, FIG. 9 shows another design example of a stator for an electrical machine based on the proposed principle. The embodiments according to FIG. 1 and FIG. 9 are connected by the fact that in FIG. 9 the recesses 5 are also present in the area of the wound teeth 3 and are also radially extended. In contrast to FIG. 1, FIG. 9 does not show coils with five electrical phases, but rather a total of seven coils assigned to seven electrical phases. The coils distributed along the circumference are labeled A1 to A7. As in FIG. 1, every second tooth is unwound. The unwound teeth are marked with reference 4. These do not have a recess 5. This is also a single-layer FSCW winding.

The mode of operation of the recesses 5 as a mechanical flux barrier can be seen in the two following FIGS. 10 and 11. FIG. 10 shows a comparison of the flux density distribution in the air gap between the stator shown in FIG. 9 and a conventional stator without recesses 5, while FIG. 11 describes this comparison for the harmonics in the air gap. It can be clearly seen that the sixth harmonic is amplified here and is used as the working wave. The fundamental waves are reduced very significantly, from almost 0.2 Tesla to around 0.05. Other significant harmonic components such as the eighth and thirteenth are also significantly reduced with the embodiment shown in FIG. 9. The other harmonic components practically do not occur anyway.

FIG. 12 shows a modification of the design of FIG. 9, which also comprises coils of seven different phases and largely corresponds to that of FIG. 9 in terms of design and mode of operation. The only difference is that the recesses 5 are not provided in the area of the wound teeth 3, but in the area of the unwound teeth 4, similar to FIG. 4. This means that every second tooth, namely the unwound teeth 4, has a recess 5, which in turn extends from the air gap through to the yoke.

From the two diagrams in FIGS. 13 and 14, which describe the flux density distribution in the air gap and the distribution of the harmonic components in the air gap respectively, it is clear that the eighth harmonic is used here as the working wave and the significant sub-harmonics thereof, namely the first and sixth harmonics, are reduced due to the recesses 5 acting as a mechanical flux barrier.

FIG. 15 again shows an embodiment according to the proposed principle of an electrical machine with the stator of FIG. 9 and a rotor 8, which here has 12 poles realized by 12 permanent magnets. This results in a number of pole pairs of six, which is adapted to the working wave, namely the sixth harmonic.

Accordingly, FIG. 16 shows a design example of the stator according to FIG. 12 combined with a rotor 9, which has 16 permanent magnets to realize a pole pair number of eight. The number of pole pairs of eight is adapted to the use of the eighth harmonic as a working wave as already described with reference to FIGS. 12 to 14.

Based on FIG. 15, FIG. 17 shows an electrical machine with a stator and a rotor, whereby the stator according to FIG. 17 does not comprise seven coils, each of which is assigned to one of seven different electrical phases, but eight. A multi-phase single-layer winding of the FSCW configuration is also shown here, with exactly one coil assigned to each phase. Furthermore, a 14-pole PM rotor 10 is provided.

In the stator 1 shown in FIG. 17, recesses 5 are again provided in the tooth area 3 of the wound teeth, whereby the unwound teeth 4 do not have a recess.

FIG. 18 shows a still further embodiment according to the proposed principle using an electrical machine with a stator and a rotor, whereby the stator, in an extension of the embodiment of FIG. 17, not only has eight coils, which are assigned to eight electrical phases, but nine. The coils are labeled A1 to A9 and exactly one coil is assigned to each electrical phase. The associated rotor 11 has 16 poles.

FIG. 19 shows an electrical equivalent circuit diagram of a multiphase winding system as used in the preceding embodiments. It can be seen that the coils assigned to each phase A1 to AK are fed by a multiphase current system, so that each coil is driven by its own individual phase current, which is at least phase-shifted to the other phase currents.

The aforementioned embodiments shown in the figures have similarities that can be described mathematically. In all embodiments, the number of phases is equal to half the number of stator slots. Furthermore, there is at least one unwound tooth between the teeth wound with coils. The stator teeth have at least one recess 5 in total. If the recess 5 is present on a wound stator tooth, then the working shaft results from the number of phases minus one. If, on the other hand, the recess is present on an unwound stator tooth, then the working shaft results from the number of phases plus one.

It should also be noted that the working shaft for a stator without a recess is smaller than for a stator with a recess.

In all embodiments, all coils have the same winding direction and the same coil sequence.

Every second stator tooth is wound with a single winding coil, while the stator teeth in between remain unwound. Each stator coil is supplied with its own phase current, which is generated individually, and represents an individual phase winding.

1. A stator for an electrical machine, the stator comprising:
stator teeth, which are distributed along a circumference of the stator; and
grooves formed between the stator teeth,
wherein coils of different phases are wound around teeth formed between the grooves, each coil corresponding to a respective wound tooth,
wherein the number of phases is greater than three,
wherein at least one unwound tooth is provided between each of the wound teeth,
wherein at least one of the wound teeth has a recess which extends substantially in a radial direction and is arranged in a tooth region, or at least one of the at least one unwound tooth has a recess which extends substantially in a radial direction and is arranged in a tooth region, and
wherein the stator teeth comprise the wound teeth and the at least one unwound tooth.

2. The stator according to claim 1, wherein all wound teeth or all unwound teeth have a recess.

3. The stator according to claim 1,
wherein the recess of the at least one of the wound teeth forms a mechanical barrier to reduce fundamental waves of a magnetic flux, and
wherein the recess of the at least one of the at least one unwound tooth forms a mechanical barrier to reduce fundamental waves of a magnetic flux.

4. The stator according to claim 1,
wherein a distance between the recesses of the at least one of the wound teeth corresponds to twice a distance between the grooves, and
wherein a distance between the recesses of the at least one of the at least one unwound tooth corresponds to twice the distance between the grooves.

5. The stator according to claim 1, wherein
a higher harmonic of a magnetomotive force different from fundamental waves is for being used as a working wave.

6. The stator according to claim 1, wherein
a multiphase single-layer winding comprising the oils is inserted into the grooves.

7. The stator according to claim 1, comprising a single-layer winding with coils of at least five different phases.

8. The stator according to claim 1, wherein
all of the coils have a same winding direction and a same coil sequence.

9. The stator according to claim 1, wherein
each of the coils is for being fed by an individual electrical phase.

10. The stator according to claim 1, wherein
the stator teeth are alternately wound and unwound along the circumference of the stator.

11. The stator according to claim 1, wherein
the stator teeth are distributed symmetrically along the circumference of the stator.

12. The electrical machine with the stator according to claim 1 and with a rotor.

13. The electrical machine according to claim 12, wherein the rotor is designed as a rotor with permanent magnets.
